(19) United States
(12) Patent Application Publication
(10) Pub. No.: US 2015/0191374 A1
(43) Pub. Date: Jul. 9, 2015

(54) REMOVAL OF TARGETED CONSTITUENTS THROUGH THE USE OF REDUCTANTS/OXIDANTS COUPLED TO A MAGNETIC SEPARATOR

(71) Applicant: ECOLAB USA INC., St. Paul, MN (US)

(72) Inventors: Daniel E. Schwarz, Naperville, IL (US); Adam A. Smith, Plainfield, IL (US); Gordon M. Carter, Evanston, IL (US); Kevin P. O'Leary, Lemont, IL (US)

(73) Assignee: ECOLAB USA INC., St. Paul, MN (US)

(21) Appl. No.: 14/446,008

(22) Filed: Jul. 29, 2014

Related U.S. Application Data
(60) Provisional application No. 61/923,309, filed on Jan. 3, 2014.

(51) Int. Cl. C02F 1/48; C02F 1/70

(52) U.S. Cl. CPC C02F 1/488; C02F 1/705; C02F 2101/106

(57) ABSTRACT

Methods and compositions for removing a targeted constituent from water are disclosed. The water including the targeted constituent may be transported into a reactor and the reactor may include a magnet and zero valent iron particles. The targeted constituent can chemically react with the zero valent iron particles and the particles may then be attracted to the magnet. The water may then pass out of the reactor free of the targeted constituent. Additionally, the zero valent iron particles may be regenerated and reused.

### CROSS-REFERENCE TO RELATED APPLICATIONS

This Application is a Utility Patent Application claiming priority from Provisional U.S. Patent Application No. 61/923,309 filed on Jan. 3, 2014.

### STATEMENT REGARDING FEDERALLY SPONSORED RESEARCH OR DEVELOPMENT

Not Applicable.

### BACKGROUND OF THE INVENTION

Selenium compounds are reported to comprise about 0.9 ppm of the earth's crust. Selenium is important as a trace mineral used to make the enzyme glutathione peroxidase, which is involved in fat metabolism and therefore found in many living organisms. It is also commonly found in various amounts in crude oil, coal, and other fossil fuels originating from the decomposed organic matter or it may be leached out of the nearby minerals. Selenium compounds are also found naturally in ground waters and in agricultural runoffs from the use of selenium containing insecticides and herbicides.

Selenium is known to be highly toxic and can be harmful even in small quantities. Harmful effects include dermatitis, central nervous system disturbance, nephrosis, hemorrhagic necrosis of the pancreas and adrenal cortex, and possibly even death. As a result, many localities have limited the permissible amount of selenium in domestic supplies of water to about 10 ppb. This restriction makes the disposal of wastewater produced from activities involving selenium-containing materials very difficult.

The chemical properties of selenium make its removal from liquids difficult and complex. Although insoluble when in its elemental state, selenium has four oxidation states (−2, +2, +4, and +6), which allow it to readily form a number of compounds that are highly soluble and therefore very difficult to remove (see Kapoor et al., Removal of Selenium from Water and Wastewater, Environmental Studies, Vol. 49, pp. 137-147 (1995)). Particularly difficult is the removal of selenate, which is fully oxidized selenium (SeO₄²⁻).

Prior art removal methods have been either disappointing or, in some cases, mostly ineffective. One prior art method, described in U.S. Pat. No. 7,419,602, involves the use of a ferric salt, pH adjustment, and an oxidant. In practice, however, this method is less than 70% effective. Another method described in U.S. Pat. No. 5,510,040 describes a method using poly dithiocarbamate materials which, while more effective, also involves considerable expense.

Thus, there is a clear need for an improved method of removing targeted constituents, such as any metal in any oxidation state, from liquid. The art described in this section is not intended to constitute an admission that any patent, publication or other information referred to herein is “prior art” with respect to this disclosure, unless specifically designated as such. In addition, this section should not be construed to mean that a search has been made or that no other pertinent information as defined in 37 C.F.R. §1.56(a) exists.

### BRIEF SUMMARY OF THE INVENTION

In at least one embodiment, the present disclosure relates to a method of removing a targeted constituent from water to form treated water. The method comprises the steps of providing a reactor comprising a magnet disposed therein and an effective amount of zero valent iron (ZVI) particles, transporting the water comprising the targeted constituent into the reactor, mixing the water with the ZVI particles such that the ZVI particles chemically react with the targeted constituent to form a ZVI/targeted constituent complex, attracting the ZVI/targeted constituent complex to the magnet such that the ZVI/targeted constituent complex is disposed on a surface of the magnet, and transporting the treated water out of the reactor.

In an additional embodiment of the present disclosure, a method for removing a targeted substituent from water comprises the steps of removing the ZVI/targeted constituent complex from the magnet, removing the targeted constituent from the ZVI particles in addition to a rust component that may have formed on the ZVI particles to form regenerated ZVI particles, transporting the removed targeted constituent and rust component out of the reactor, and reusing the regenerated ZVI particles in the reactor.

Additional features and advantages are described herein, and will be apparent from, the following Detailed Description.

### BRIEF DESCRIPTION OF THE DRAWINGS

A detailed description of the invention is hereafter described with specific reference being made to the drawings in which:

FIG. 1 is a flow-chart depicting one embodiment of a method for removing a targeted constituent from water.

This drawing FIGURE is only an exemplification and is not intended to limit the disclosure to the particular embodiments illustrated.

### DETAILED DESCRIPTION OF THE INVENTION

The following definitions are provided to determine how terms used in this application, and in particular how the claims, are to be construed. The organization of the definitions is for convenience only and is not intended to limit any of the definitions to any particular category.

“Consisting Essentially of” means that the methods and compositions may include additional steps, components, ingredients or the like, but only if the additional steps, components and/or ingredients do not materially alter the basic and novel characteristics of the claimed methods and compositions.

“Effective amount” means a dosage of any additive that affords an increase in one of the three quantiles when compared to an undosed control sample.

“Flocculant” means a composition of matter which when added to a liquid carrier phase within which certain particles are thermodynamically inclined to disperse, induces agglomerations of those particles to form as a result of weak physical forces such as surface tension and adsorption, flocculation often involves the formation of discrete globules of particles aggregated together with films of liquid carrier interposed between the aggregated globules, as used herein flocculation includes those descriptions recited in ASTME 20-85 as well as those recited in Kirk-Othmer Encyclopedia of Chemical Technology, 5th Edition, (2005), (Published by Wiley, John & Sons, Inc.).

“Thickener” or “Settler” means a vessel used to effect a solid-liquid separation of a slurry, often with the addition of flocculants, the vessel constructed and arranged to receive a slurry, retain the slurry for a period of time sufficient to allow solid portions of the slurry to settle downward (underflow) away from a more liquid portion of the slurry (overflow), decant the overflow, and remove the underflow. Thickener underflow and thickener overflow are often passed on to filters to further separate solids from liquids.

In the event that the above definitions or a description stated elsewhere in this application is inconsistent with a meaning (explicit or implicit) which is commonly used, in a dictionary, or stated in a source incorporated by reference into this application, the application and the claim terms in particular are understood to be construed according to the definition or description in this application, and not according to the common definition, dictionary definition, or the definition that was incorporated by reference. In light of the above, in the event that a term can only be understood if it is construed by a dictionary, if the term is defined by the Kirk-Othmer Encyclopedia of Chemical Technology, 5th Edition, (2005), (Published by Wiley, John & Sons, Inc.) this definition shall control how the term is to be defined in the claims.

At least one embodiment of the present application is directed to the removal of a targeted constituent from water, such as groundwater or wastewaters. A targeted constituent may be any constituent found in the water that can be removed by zero valent iron. A targeted constituent may comprise a member selected from the group consisting of metals, organics, nitrates, and any combination thereof. The term “targeted constituent” or “a targeted constituent” is intended to cover both a single constituent, such as selenium, and also multiple constituents, such as selenium, mercury, an organic, etc. In some embodiments, the targeted constituent is a metal, such as a heavy metal, or the targeted constituent may comprise multiple metals, such as selenium, mercury, and copper. The metal and/or heavy metal may be in any oxidation state. For example, selenium has an elemental state, in addition to four oxidation states (−2, +2, +4, and +6). Fully oxidized selenium (SeO₄²⁻) may be referred to as selenate. Heavy metals are well-known in the art and illustrative, non-limiting examples of heavy metals are selenium, chromium, mercury, nickel, zinc, arsenic, and copper. The present disclosure is intended to cover removal of metals and/or heavy metals in any of their respective oxidation states.

Embodiments of the present disclosure are intended to cover removal of a targeted constituent from water and illustrative, non-limiting examples of water include groundwater, wastewater from refineries, wastewater from power plants, wastewater from mining operations, and wastewater from manufacturing operations.

In certain embodiments, the present disclosure is directed to the removal of a targeted constituent from water using elemental iron. Elemental iron may also be referred to as zero valent iron or “ZVI.” ZVI and uses thereof are described in, for example, Cundy, A. B. et al., Use of iron-based technologies in contaminated land and groundwater remediation: A review, Science of the Total Environment 400 (2008) 42-51, the disclosure of which is incorporated into the present application in its entirety.

In some embodiments, when ZVI is added to the water containing the one or more metal targeted constituents, the ZVI may reduce the metal to a form that is insoluble in, and thus separable from, the wastewater. In some aspects, a chemical reaction occurs between the metal and the ZVI and the metal may adhere to the ZVI particle. In other aspects, a chemical reaction may occur between the metal and the ZVI and subsequently, the reacted metal may be released from the ZVI particle and suspended in the water. In some embodiments, a chemical, such as a flocculant and/or coagulant, may be added to the water to flocculate and/or coagulate the suspended reacted metals thereby assisting in the removal of these constituents from the water.

Various types of chemical reactions may occur between the targeted constituent and the ZVI particle. Illustrative, non-limiting examples of chemical reactions are as follows:

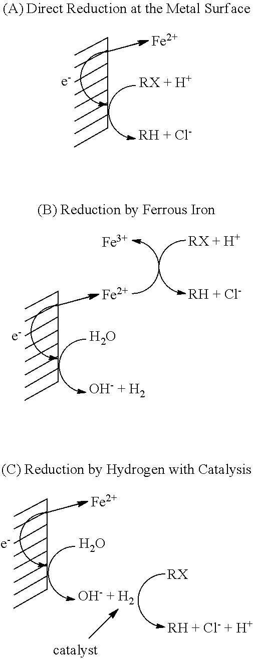

ZVI may be added to the water to be treated in any amount effective for removal of a targeted constituent therefrom. In some embodiments, from about 1,000 mg/L to about 25,000 mg/L of ZVI may be added to the water to be treated. In other embodiments, from about 5,000 mg/L to about 10,000 mg/L of ZVI may be added to the water to be treated.

ZVI may be added to the water in an appropriate apparatus/reactor that will allow for mixture of the water with the ZVI. Alternatively, ZVI may be added to the reactor and the water to be treated may be passed therethrough, thereby contacting the ZVI and allowing a chemical reaction to occur between the targeted constituent in the water and the ZVI. In some embodiments of the present disclosure, the ZVI treatment may be used in connection with a magnetic ballasted reactor (MBR) to effect removal of targeted constituents from the waters. In some aspects, the apparatus may be a magnetic ballasted clarification (MBC) apparatus, such as that described in any of U.S. Pat. No. 7,691,269, U.S. Pat. No. 7,255,793, U.S. Pat. No. 7,820,053, U.S. Pat. No. 7,625,490, U.S. Pat. No. 6,896,815, and U.S. Pat. No. 7,686,960, the disclosures of which are expressly incorporated into the present application in their entirety. In other aspects, the ZVI treatment may be used in connection with a non-magnetic ballasted clarification apparatus. Ballasted clarification is a process known in the art that offers an effective means for removal of particulates by enmeshment in a heavy specific gravity clarification blanket. In any aspect, the water to be treated may be present in the reactor for a sufficient period of time to allow for mixing/reaction of the ZVI particles and targeted constituent. In some aspects, this period of time may be from about 1 minute to about 120 minutes or any sub-range thereof, such as from about 5 minutes to about 60 minutes.

In one embodiment of the present disclosure, the apparatus used to mix the ZVI with the water to be treated may be a MBR. The MBR includes a mixing tank comprising the ZVI where the water comprising the targeted constituent and any additional chemicals, such as flocculants, may be added and/or passed through. In some aspects, the tank may further comprise mixers, cleaning discs, and separation drums. The influent water is introduced into an inlet in the reactor and the chemical reaction, separation steps, and optional regeneration steps, may take place within the reactor. Effluent water, excluding the removed targeted constituent and ZVI, may exit the reactor via a first exit passageway. The ZVI/targeted constituent may be further treated in the reactor or they may be removed from the reactor via alternate passageways.

In some aspects, after reaction of the ZVI with a targeted constituent, the surface of the ZVI particle may comprise rust (including Fe₂O₃) and/or targeted constituent, and the ZVI may be regenerated in the reactor for reuse of the ZVI particles. The rust and/or targeted constituent that is removed from the surface of the ZVI particle during regeneration is subsequently removed from the reactor and dewatered. In an alternate aspect, the ZVI particles may be regenerated outside of the reactor and the regenerated particles may then be reintroduced into the reactor to treat additional water (remove targeted constituents therefrom).

ZVI is particularly advantageous in the processes disclosed in the present application because it has a specific gravity range from about 2 to about 7. Further, ZVI can be produced with relatively small particle sizes to provide a large surface area for reactions to take place to affect targeted constituent removal. In some embodiments, the particle sizes of the ZVI may range from about 1 to about 100 μm. In other aspects, the particle size may range from about 30 to about 50 μm. Additionally, ZVI is magnetic and can therefore be removed from treated water through its magnetic, as well as its physical, properties. Finally, ZVI is an extremely effective reductant.

In some embodiments of the present disclosure, after the ZVI particle has been mixed with the water to be treated and used for removal of a targeted constituent, it may be regenerated for reuse. Regeneration may be necessary because when the ZVI particle comes into contact with the targeted constituent, a chemical reaction may take place between the targeted constituent and the ZVI particle and the targeted constituent may thereafter adhere to the ZVI particle and/or the surface of the ZVI particle may comprise rust, rendering the particle ineffective for further constituent removal. In one aspect, regeneration is carried out, either inside the reactor or outside the reactor, by separating the ZVI particle from the rust and/or targeted constituent using physical force, such as mechanical shearing/scraping. For example, the reactor may comprise a mechanical, abrasive, regeneration device that may subject the ZVI particles to abrasive forces, through the use of blades spinning therein (similar to a blender) and/or by causing the particles to collide with one another, thereby removing the rust and/or targeted constituent from the surface of the ZVI particle. Any abrasive process may be used to remove the rust and/or targeted constituent from the surface of the ZVI particle. The rust and/or targeted constituent may then be separated from the ZVI particle and removed from the reactor and the regenerated ZVI particle may be reused.

Regeneration may also be carried out by chemical methods comprising removing the iron particles from the separation apparatus and treating the ZVI particles with various chemicals known in the art for removal of rust/targeted constituents from the surface of the ZVI particles. In yet a further aspect, physical force may be used to separate the precipitated metals from the ZVI and zone settling may be used, particularly in view of the high specific gravity of ZVI (which allows the ZVI to settle much more quickly than the separated metals), for separation of the wastewater mixture into two streams (one stream being a regenerated ZVI slurry and the other stream comprising the metals).

In some aspects, the presently disclosed reactor comprises one or more magnets, such as magnets comprising rare-earth metals. After the ZVI particles contact the water to be treated and undergo a chemical reaction with the targeted constituent, the ZVI particle/targeted constituent complex is attracted to a magnet and disposed thereon to allow the cleaned, effluent water to exit the apparatus without the ZVI particles and the targeted constituent. The ZVI particle/targeted constituent complex may then be mechanically removed from the magnet by mechanical shearing, a doctor blade, or the like, and subjected to a regeneration step.

In some embodiments, the present disclosure addresses the problem of targeted constituent removal from water by treating the water with ZVI. In other embodiments, additional treatment steps may be carried out but these treatment steps are not required. For example, in some embodiments, the water may be pretreated before exposure to the ZVI. In some aspects, the pretreatment step may comprise a pH adjustment step. In certain aspects, the water to be treated may be adjusted such that it is acidic. For example, the pH of the water may be adjusted to about 7 or less, or between about 3 and about 6, by addition of an acid or a base. Any acid may be used to adjust the pH and representative acids that may be used are sulfuric acid, hydrochloric acid, nitric acid, phosphoric acid, and citric acid. Carbon dioxide may also be used to adjust the pH of the water to be treated. Also, any base may be used to adjust the pH of the water, such as sodium hydroxide.

Additionally, a process for removal of a targeted constituent from water in accordance with the present disclosure may comprise a step where the water is treated with other metal-removing chemistries. This additional treatment step(s) may occur before the ZVI treatment step, after the ZVI treatment step, both before and after the ZVI treatment step, or it may not occur at all. For example, a process of the present disclosure may include an additional treatment step wherein the water is treated with an effective amount of a water soluble ethylene dichloride ammonia polymer that contains from about 5 to about 50 mole percent of dithiocarbamate salt group. In some aspects, the additional treatment step may comprise passing the treated water through a filter device. In certain aspects, the additional treatment may comprise treating the water with a composition comprising a polymer derived from at least two monomers, such as an acrylic-based monomer and an alkylamine. The polymer may be modified to contain a functional group capable of scavenging one or more metals. Such additional treatment steps may be found and further explained in U.S. Ser. No. 12/107,108, U.S. Ser. No. 11/516,843, U.S. Ser. No. 11/695,819, U.S. Pat. No. 8,585,994, U.S. Pat. No. 8,211,389, and U.S. Pat. No. 8,110,163, the entire disclosures of which are expressly incorporated into the present application by reference in their entirety.

Thus, in one illustrative embodiment, the present disclosure relates to a process for removal of a targeted constituent from water whereby the water is pretreated with an acid to adjust its pH to a range of between about 1 and about 7. The pretreated water may be then be transported to a tank and an additional treatment step may occur, such as a step of adding a water soluble ethylene dichloride ammonia polymer that contains from about 5 to about 50 mole percent of a dithiocarbamate salt group to the pretreated water. This step may or may not be followed by a solid/liquid separation step. Subsequently, the treated water may then be passed through a reactor comprising ZVI particles to polish the water, bring targeted constituent contamination to very low levels, and, in some aspects, remove the metals that are highly problematic to remove, in some cases due to their oxidation state or chelation. In some embodiments, this step may be followed by a solid/liquid separation step. Finally, if necessary, an additional treatment step, as described above, may be carried out on the treated/cleaned effluent to, for example, remove any solubilized iron in the water.

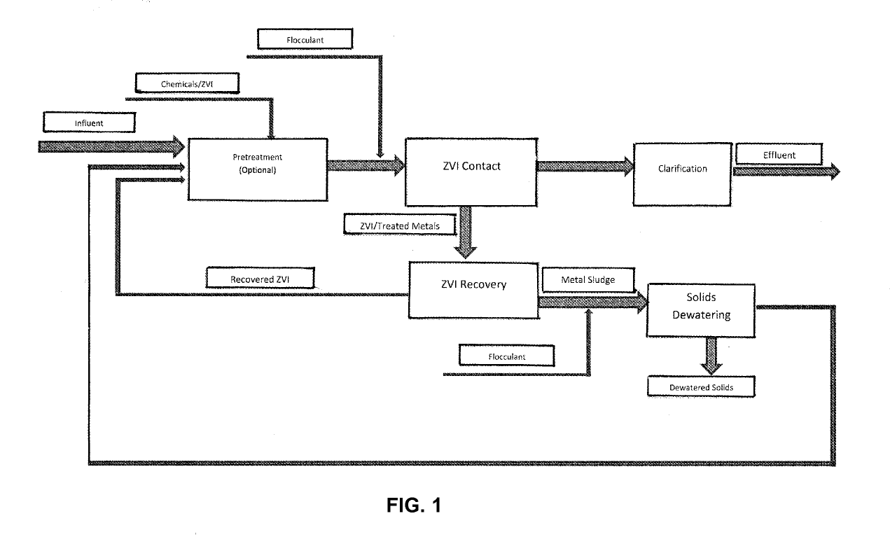

In an additional embodiment, the ZVI treatment step serves as the sole treatment mechanism, as can be seen in FIG. 1. In this embodiment, although the water influent may optionally be treated with various chemicals to provide a desired pH or oxidation-reduction potential (ORP), this step is not required and instead, the water to be treated may simply be introduced into the reactor comprising the ZVI particles. The water to be treated (influent) is passed through and mixed with regenerated and/or fresh ZVI particles. The targeted constituent in the water chemically reacts with the ZVI particles and may then become insoluble in the water and attached to the surface of the ZVI particle. The ZVI particle/targeted constituent complex may be attracted to and disposed on a magnet in the reactor and the cleaned effluent may pass out of the reactor free of the targeted constituent and ZVI particles. The ZVI particle/targeted constituent complex may be removed from the magnet and subjected to an agitation step to remove any targeted constituent and/or rust from the ZVI particle surface. The recovered/regenerated ZVI may be reused, and the separated rust/targeted constituent solids are removed from the reactor and dewatered. As can be seen in FIG. 1, optional flocculants may be added in the initial ZVI/water mixing step and they also may be added to the separated rust/targeted constituent solids prior to dewatering.

After the water has been subjected to the ZVI treatment, and any optional pretreatment or additional treatment steps, the water will be completely or substantially free of targeted constituents.

Additional chemicals may be used in connection with the presently disclosed methods for removing targeted constituents from water and these chemicals may be added to the water in any of the treatment or pretreatment steps described in this application. For example, the presently disclosed methods may comprise adding any known acids, bases, oxidants (such as hydrogen peroxide), coagulants (such as coagulants based on iron, coagulants based on aluminum, diallyldimethylammonium chloride (DADMAC) based coagulants, epichlorhydrin-dimethylamine based coagulants, etc.) flocculants (such as high molecular weight (greater than 1,000,000) anionic, nonionic, and/or cationic polymers that may be acrylamide-based), and any combination thereof, to the water. In one aspect, for example, a flocculant and/or coagulant may be added to a reactor comprising the water to be treated after the ZVI addition. In some aspects, the targeted constituent may chemically react with the ZVI particle and subsequently it may be released by the ZVI particle and suspended in the water. A flocculant and/or coagulant may be added to flocculate or coagulate the suspended targeted constituent and cause it to adhere to the ZVI particle. However, in some aspects of the present disclosure, a process for removal of a targeted constituent from water specifically excludes the use of coagulants and/or flocculants and instead, the water to be treated is passed through a reactor comprising only (consisting of) the ZVI particles.

Heretofore, a system that retains ZVI particles therein using magnets and also regenerates ZVI particles that have been oxidized by targeted constituents has not been disclosed. Instead, certain prior art processes involve the use of magnetite as a ballast and polymers, usually coagulants and/or flocculants, to act as a “glue” to adhere certain materials to the magnetite particles. The targeted materials (such as dissolved metals) in these systems do not chemically react with the outer surface of the magnetite particles but instead, they are physically adsorbed onto the magnetite particle surface using a flocculant or coagulant.

### EXAMPLES

The foregoing may be better understood by reference to the following examples, which are presented for purposes of illustration and are not intended to limit the scope of this disclosure. In particular, the examples demonstrate representative examples of principles innate to the disclosure and these principles are not strictly limited to the specific conditions recited in these examples. As a result, it should be understood that the disclosure encompasses various changes and modifications to the examples described herein and such changes and modifications can be made without departing from the spirit and scope of the disclosure and without diminishing its intended advantages. It is therefore intended that such changes and modifications be covered by the appended claims.

The data depicted in the following table includes data gathered from several different iterations of experimental testing. General experimental procedures that were followed for testing are described below.

In all trials, refinery wastewater was used and the targeted constituent was selenium in certain oxidation states. Experiments were run using jar testing where each sample had its own separate jar. The selenium reporting limit was set to 0.002 mg/L. In the tables, “CHEAP” refers to Ferox™—Flow (D)—ZVI and “MID” refers to Ferox™—Flow—ZVI.

With respect to the Series 1 data, the ORP of the wastewater was adjusted to +250 mV by adding a sufficient amount of 30% hydrogen peroxide. Then, the pH of the wastewater was adjusted to about 6.0 using a sufficient amount of sulfuric acid. Subsequently, about 125 ppm of an iron-based coagulant (8131) was added to the jar and allowed to react with mixing for 15 minutes. Then, about 250 ppm of a water soluble ethylene dichloride ammonia polymer that contains from about 5 to about 50 mole percent of dithiocarbamate salt group (1689) was added to each jar with mixing. Each jar was then allowed to settle for about 15 minutes before ZVI was then added to the wastewater with mixing, for example by using a gang stirrer, for about 30 minutes. After settling, an effluent sample was taken from the jar using a 60 mL syringe and submitted for selenium analysis.

Series 2 was conducted using similar procedures to Series 1 except no 8131 or 1689 was added.

Series 3 was also conducted using similar procedures to Series 1 but after removing an aliquot for testing from sample 1-B, the remaining effluent from that sample was discarded, leaving the settled sludge and ZVI in the beaker. This ZVI was then recycled and used in the jar for sample 2-B. The same procedure was used again after sample 2-B for samples 5-B, 7-B, and 10-B (e.g. these samples all used recycled ZVI). In some of the samples, the targeted constituent (selenium) was reduced by over 99%.

| | Treat Order | | | | | |
|---|---|---|---|---|---|---|
| | 1 | 2 | 3 | | 4A | 5 |
| | Local Sample ID | | | | | |
| | Addition of | pH | Additon | | | |
| | Peroxide | Adjusted | of | | | |
| | to +250 | with | 125 ppm | | | |
| | mV ORP on | H₂SO₄ | 8131; 250 | | | Unfiltered |
| | Influent | to 6.0 | ppm 1689 | ZVI Type | ZVI Dosage | Selenium |
| XXXX | YES or NO | YES or NO | YES or NO | CHEAP or MID | g per 200 mL | mg/L |
| SERIES 1 | | | | | | |
| Blank | N/A | N/A | N/A | N/A | N/A | 0.440 |
| M | YES | YES | YES | CHEAP | 0.0 | 0.035 |
| N | YES | YES | YES | CHEAP | 0.2 | <0.002 |
| O | YES | YES | YES | CHEAP | 0.5 | <0.002 |
| P | YES | YES | YES | CHEAP | 1.0 | 0.025 |
| Q | YES | YES | YES | CHEAP | 0.5 | <0.002 |
| R | YES | YES | YES | CHEAP | 0.5 | 0.015 |
| S | YES | YES | YES | CHEAP | 0.5 | <0.002 |
| SERIES 2 | | | | | | |
| Blank | N/A | N/A | N/A | N/A | N/A | 0.440 |
| 1-D | YES | YES | NO | CHEAP | 0.1 | 0.030 |
| 2-D | YES | YES | NO | CHEAP | 0.2 | 0.040 |
| 3-D | YES | YES | NO | CHEAP | 0.4 | 0.035 |
| 4-D | YES | YES | NO | CHEAP | 0.8 | 0.030 |
| 1-E | YES | YES | NO | MID | 0.1 | 0.040 |
| 2-E | YES | YES | NO | MID | 0.2 | <0.002 |
| SERIES 3 | | | | | | |
| Blank | N/A | N/A | N/A | N/A | N/A | 0.344 |
| 1-A | NO | YES | NO | MID | 1.8 | 0.195 |
| 2-A | NO | YES | NO | MID | 0.0 | 0.196 |
| 5-A | NO | YES | NO | MID | 0.0 | 0.246 |
| 1-B | YES | YES | NO | MID | 1.8 | 0.065 |
| 2-B | YES | YES | NO | MID | 1.8 | <0.002 |
| 5-B | YES | YES | NO | MID | 1.8 | 0.033 |
| 7-B | YES | YES | NO | MID | 1.8 | <0.002 |
| 10-B | YES | YES | NO | MID | 1.8 | 0.051 |

While this invention may be embodied in many different forms, there are described in detail herein specific embodiment. The present disclosure is an exemplification of the principles of the invention and is not intended to limit the invention to the particular embodiments illustrated. All patents, patent applications, scientific papers, and any other referenced materials mentioned herein are incorporated by reference in their entirety.

Furthermore, the invention encompasses any possible combination of some or all of the various embodiments mentioned herein, described herein and/or incorporated herein. In addition, the invention encompasses any possible combination that also specifically excludes any one or some of the various embodiments mentioned herein, described herein and/or incorporated herein. The above disclosure is intended to be illustrative and not exhaustive. This description will suggest many variations and alternatives to one of ordinary skill in this art. All of these alternatives and variations are intended to be included within the scope of the claims where the term “comprising” means “including, but not limited to.” Those familiar with the art may recognize other equivalents to the specific embodiments described herein, which equivalents are also intended to be encompassed by the claims.

All ranges and parameters disclosed herein are understood to encompass any and all sub-ranges subsumed therein, and every number between the endpoints. For example, a stated range of “1 to 10” should be considered to include any and all sub-ranges between (and inclusive of) the minimum value of 1 and the maximum value of 10. That is, all sub-ranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range. All percentages, ratios, and proportions herein are by weight unless otherwise specified.

This completes the description of the preferred and alternate embodiments of the invention. Those skilled in the art may recognize other equivalents to the specific embodiments described herein, which equivalents are intended to be encompassed by the claims attached hereto.

1. A method of removing a targeted constituent from water to form treated water comprising:
providing a reactor comprising a magnet disposed therein and an effective amount of zero valent iron (ZVI) particles;
transporting the water comprising the targeted constituent into the reactor;
mixing the water with the ZVI particles such that the ZVI particles chemically react with the targeted constituent to form a ZVI/targeted constituent complex;
attracting the ZVI/targeted constituent complex to the magnet such that the ZVI/targeted constituent complex is disposed on a surface of the magnet; and
transporting the treated water out of the reactor.

2. The method of claim 1, further comprising the steps of:
removing the ZVI/targeted constituent complex from the magnet;
removing the targeted constituent from the ZVI particles in addition to a rust component that may have formed on the ZVI particles to form regenerated ZVI particles;
transporting the removed targeted constituent and rust component out of the reactor; and
reusing the regenerated ZVI particles in the reactor.

3. The method of claim 2, wherein the ZVI/targeted constituent complex is subjected to mechanical agitation to remove the targeted constituent and rust component from the ZVI particles.

4. The method of claim 1, further comprising the step of pretreating the water comprising the targeted constituent with an acid to adjust a pH of the water to between about 1 and about 7 before transporting the water into the reactor.

5. The method of claim 1, further comprising the step of treating the water comprising the targeted constituent with an effective amount of a water soluble ethylene dichloride ammonia polymer that contains from about 5 to about 50 mole percent of a dithiocarbamate salt group before transporting the water into the reactor.

6. The method of claim 1, further comprising the step of treating the treated water with an effective amount of a water soluble ethylene dichloride ammonia polymer that contains from about 5 to about 50 mole percent of a dithiocarbamate salt group after the treated water is transported out of the reactor.

7. The method of claim 1, further comprising the step of passing the treated water through a filter device after the treated water is transported out of the reactor.

8. The method of claim 1, further comprising the step of passing the water comprising the targeted constituent through a filter device before the water is transported into the reactor.

9. The method of claim 1, further comprising the step of treating the water comprising the targeted constituent with a composition comprising a polymer derived from at least two monomers that has been modified to contain a functional group capable of scavenging a metal before the water is transported into the reactor.

10. The method of claim 1, further comprising the step of treating the treated water with a composition comprising a polymer derived from at least two monomers that has been modified to contain a functional group capable of scavenging a metal after the treated water has been transported out of the reactor.

11. The method of claim 1, wherein the targeted constituent is a component of the water that can be removed by ZVI.

12. The method of claim 1, wherein the targeted constituent is selected from the group consisting of a metal, an organic, a nitrate, and any combination thereof.

13. The method of claim 1, wherein the targeted constituent comprises selenate.

14. The method of claim 1, wherein the water is selected from the group consisting of groundwater, wastewater from refineries, wastewater from power plants, wastewater from mining operations, wastewater from manufacturing operations, and any combination thereof.

15. The method of claim 1, wherein the effective amount of ZVI is from about 1,000 mg/L to about 25,000 mg/L of water.

16. The method of claim 1, wherein the ZVI particles have particle sizes between about 1 μm and about 100 μm.

17. The method of claim 1, wherein a coagulant and/or a flocculant is not added into the reactor.

18. The method of claim 1, wherein during the mixing step, the water consists of the ZVI particles, the target constituent, and the ZVI/targeted constituent complex, and no additional chemicals are added into the water.
